(19) United States
(12) Patent Application Publication
(10) Pub. No.: US 2007/0184324 A1
(43) Pub. Date: Aug. 9, 2007

(54) SOLID OXIDE FUEL CELL CATHODE COMPRISING LANTHANUM NICKELATE

(75) Inventors: Karen Swider Lyons, Alexandria, VA (US); Christel Laberty, Paris (FR); Feng Zhao, Salt Lake City, UT (US); Anil V. Virkar, Salt Lake City, UT (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(73) Assignee: The Government of the US, as represented by the Secretary of the Navy, Washington, DC (US)

(21) Appl. No.: 11/627,485

(22) Filed: Jan. 26, 2007

Related U.S. Application Data
(60) Provisional application No. 60/762,223, filed on Jan. 26, 2006.

(51) Int. Cl. H01M 8/12; C04B 35/50; H01M 8/04

(52) U.S. Cl. 429/33; 501/152; 429/26; 429/13

(57) ABSTRACT

A solid mixture of La₂NiO_{4+δ} and an ionic conductive material. A solid oxide fuel cell having a cathode interlayer having a La₂NiO_{4+δ} layer and a doped ceria layer, a lanthanum strontium cobaltite or lanthanum strontium manganate cathode current collector, an anode; and an ionic conductive electrolyte between and in contact with the cathode interlayer and the anode.

This application claims the benefit of U.S. Provisional Patent Application No. 60/762,223, filed on Jan. 26, 2006, incorporated herein by reference.

### FIELD OF THE INVENTION

The invention relates generally to compositions comprising lanthanum nickelate and fuel cells made therefrom.

### DESCRIPTION OF RELATED ART

Few materials exhibit the catalytic, electrical and mechanical properties required for high activity and durability in a high power density solid oxide fuel cells (SOFCs) cathode. Up to 60% of voltage loss in anode-supported SOFCs can occur at the cathode, particularly at 800° C. and lower temperatures, due to polarization losses associated with the oxygen reduction reaction (ORR) for the reduction of oxygen gas to oxygen ions, O²⁻ (Eq. 1).¹ (All referenced publications and patent documents are incorporated herein by reference.).
O₂+4e⁻=2O²⁻ (1)

State of the art SOFCs utilize porous composite cathodes whereby the ORR primarily occurs at the three-phase-botuidary (TPB) between an oxygen-ion conductor, an electronic conductor, and the gas phase, to transport each species in Eq. 1. Considerable work has been reported on cathode mechanisms and their dependence on materials properties and microstructure, mainly via ex-situ measurements and electrochemical characterization of individual materials (half-cell measurements).¹

Composite cathodes typically are a mixture of strontium-doped lanthanum manganite (LSM), which has low electronic resistance, but is a poor ionic conductor, and yttria-stabilized zirconia (YSZ), which is a good oxygen-ion conductor, but has high electronic resistance. Through optimization of the TPB and porosity, high performance cells with LSM+YSZ-composite cathodes have been developed. Important electrocatalytic properties of composite cathodes are low electronic resistivity, ρₑ, low ionic resistivity, ρᵢ, low charge transfer resistivity, ρ_{ct}, combined with high TPB length, l_{TPB} and appropriate porosity, Vᵥ.² The highest perfortice of LSM+YSZ-based cathodes, ˜1.9 W/cm² at 800° C., has been measured in SOFC button cells using “bi-layer” cathodes wherein the LSM-YSZ composite is restricted to ˜20 μm thick “interlayer” in contact with the electrolyte where the ORR occurs.³ The mixed conducting cathode interlayer, or cathode catalyst layer, is covered with a 50 μm thick, low impedance LSM “current collector.” This is supported on an 8 to 10 μm thick YSZ electrolyte and a YSZ/Ni composite anode.

Most YSZ-based SOFCs are fabricated with LSM cathodes. The perovskite structure of LSM has cation defects that facilitate p-type electronic conductivity on the order of 100 S·cm² in air at 700° C. Additionally, LSM has good thermal and chemical stability with the commonly used YSZ electrolyte and mechanical strength at high temperatures. However, below 800° C., the overpotential of LSM electrodes on YSZ is significant, resulting in low current densities. The electrochemical activity of LSM cathodes has been improved by adding YSZ to improve mixed conduction of the solid phase.⁴ The oxygen-ion conductivity of the YSZ in combination with the metallic LSM increases the TPB for the ORR. The performance of the electrodes, as determined by their impedance, can be very sensitive to the fabrication procedures, which affect how the YSZ and LSM are interconnected.⁴ It has also been shown that the performance of the cell can depend strongly on the microstructure and the geometry of the cell for a given materials set.³ Further, the performance of the cell can be improved by using 5 layers of anode supported SOFC. For example, the maximum power density achieved was 1.8 W/cm² at 800° C. and 0.4 W/cm² at 600° C. for an optimized cell this given materials set (LSM, YSZ, Ni).³

### SUMMARY OF THE INVENTION

The invention comprises a composition of matter comprising a solid mixture of La₂NiO_{4+δ} and an ionic conductive material.

The invention further comprises a solid oxide fuel cell comprising: a cathode interlayer comprising a La₂NiO_{4+δ} layer and a doped ceria layer; a cathode current collector comprising lanthanum strontium cobaltite or lanthanum strontium manganate; an anode; and an ionic conductive electrolyte between and in contact with the cathode interlayer and the anode.

### BRIEF DESCRIPTION OF THE DRAWINGS

A more complete appreciation of the invention will be readily obtained by reference to the following Description of the Example Embodiments and the accompanying drawings.

FIG. 1 shows cell voltage and power density as a function of the current density for a SOFC dime cell with a bi-layer cathode having an LN and SDC interlayer and an LSC current collector and a 0.5 mm Ni/YSZ anode at 600, 700, and 800° C. (Cell 6 in Table 2).

FIG. 2 shows area specific resistance (ASR_{ohmic}, ASRₜₒₜₐₗ, vs. ΔASRₚₒₗₐᵣ) vs. measured maximum power density at 800° C. of Cells 1-6 from Table 2.

FIG. 3 shows a parametric fit of the polarization curve of Cell 6 at 800° C. (LN/SDC cathode interlayer and LSC current collector). The fit is valid above about 0.5 A/cm where the Tafel equation is applicable.

FIG. 4 shows a schematic of the single cell testing apparatus used.

FIG. 5 shows voltage and power density vs. current density plots for a porous (La₂NiO_{4+δ}+SDC) interlayer and porous LSC current collector.

FIG. 6 shows the measured ohmic voltage loss as a function of current density for a porous (La₂NiO_{4+δ}+SDC) interlayer and porous LSC current collector.

### DETAILED DESCRIPTION OF EXAMPLE EMBODIMENTS

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

A long-term goal for improving SOFC cathodes has been to use a single-phase mixed ionic-electronic conductor (MIEC) rather than composites of ionically and electronically conducting ceramics, so that the oxygen reduction reaction (ORR) occurs over the entire surface of the cathode material rather than at the triple phase boundary (TPB) between the composite and gas phases. Lanthanum nickelate (LN, La₂NiO_{4+δ}) is one MIEC with properties that should make it a good cathode catalyst. The LN performs poorly (0.3 W/cm²) when it is used as a single-phase cathode in yttria-stabilized-zirconia-based air-H₂ button cells at 800° C. Power densities up to 2.2 W/cm² are measured only when LN is used in a composite bi-layer cathode. The performance of the electrodes is fit with a parametric model for composites. The results suggest that the ORR may preferentially occur at a TPB, and composite electrodes are best for SOFC cathodes.

A potentially promising path for further increasing the cathode activity is to use single-phase, porous mixed ionic-electronic conductors (MIECs) for the catalysts, whereby there is a two-phase boundary between the ions and electrons in the solid phase and oxygen gas, and the entire surface available for the ORR rather than restricted to the TPB. Independent of microstructural and electrical parameters, the 1 D macrohomogeneous model for the impedance response of MIEC under zero-bias conditions predicts that the chemical impedance is inversely proportional to \sqrt{D*k}, where D* is the oxygen self-diffusion coefficient and k is the oxygen surface exchange coefficient.^{5,6} Up to now, this model has been verified on half-cell measurements with no imposed current.

Table 1 lists the electrical and kinetic properties of various materials used in SOFC cathodes. High performance cathodes have been made using the perovskites, La_{0.7}Sr_{0.3}MnO₃(LSM),³ La₁₋ₓSrₓCo_{1-y}Fe_{y}O_{3-d}(LSCF).⁷ and La₁₋ₓSrₓCoO_{3-d}(LSC).^{8,9} The MIEC model predicts that D and k values equal to or greater than, respectively 10⁻⁸ cm²/s and 10⁻⁶ cm/s are needed to produce low ASR values.⁶ Although the D* and k values of LSM and LSCF are apparently deficient, they are used in composites with ionic conductors, for instance YSZ/LSM^{3,10} and LSCF/GDC^{6,8} whereby their D* and k values are reportedly 2 orders of magnitude higher than their single constituents due to spillover effects.^{6,10} Table 1 indicates that LSC should be the best cathode, with the highest D* and k values plus high electronic and ionic conductivity. Unfortunately, LSC deleteriously reacts with YSZ when sintered above 1000° C., thereby prohibiting the manufacture of a single-phase MIEC cathode SOFCs. LSC has been used successfully in cathodes either by separation from the YSZ by a SDC thin film, ⁷ or infiltration into a porous YSZ network;⁹ both which are composite approaches, preventing the analysis of the single LSC phase.

TABLE 1
Properties of materials used in SOFC cathodes including electronic
resistivity, total electrical resistivity, oxygen-ion resistivity, oxygen self-diffusion
coefficient, D*, and the oxygen surface exchange coefficient, k, at 800° C. and ≧0.21 atm.
Where the value has not been reported, it is estimated from analogous
compounds, designated as (est). Negligible values are designated as (—).

| | Electronic | Total electrical | Ionic | | | |
|---|---|---|---|---|---|---|
| | resistivity | resistivity | resistivity | D* | k | |
| Materials | (Ω · cm) | (Ω · cm) | (Ω · cm) | (cm²/s) | (cm/s) | Reference |
| La_{0.7}Sr_{0.3}MnO₃(LSM) | 0.005 | 0.005 | — | 4 × 10⁻¹⁵ | 1 × 10⁻⁸ | 10, 11 |
| La_{0.7}Sr_{0.3}MnO₃(LSM) | 0.005 | 0.005 | — | 4 × 10⁻¹⁵ | 1 × 10⁻⁸ | 10, 11 |
| La_{0.7}Sr_{0.3}CoO₃ (LSC) | 0.003 | 0.003 | 500 (est) | 2 × 10⁻⁶ | 2 × 10⁻⁵ | 12, 13 |
| La_{0.6}Sr_{0.4}Co_{0.2}Fe_{0.8}O₃ | 0.004 | 0.004 | 500 (est) | 7 × 10⁻⁹ | 6 × 10⁻⁷ | 14, 15 |
| (LSCF) | | | | | | |
| La₂NiO_{4+δ} (LN) | 3 | 3 | 500 (est) | 2 × 10⁻⁷ | 2 × 10⁻⁶ | 16, 17 |
| Sm_{0.2}Ce_{0.8}O₂ (SDC) | — | 20 | 20 | 2 × 10⁻⁷ | 3 × 10⁻⁸ | 18 |
| | | | | (est) | (est) | |
| Gd_{0.1}Ce_{0.9}O_{1.95} (GDC) | — | 20 | 20 | 2 × 10⁻⁷ | 3 × 10⁻⁸ | 19, 20 |
| YSZ | — | 50 | 50 | 1 × 10⁻⁷ | 8 × 10⁻⁸ | 11, 19 |

Table 1 shows that the k of LN, 2×10⁻⁶ cm/s, is an order-of-magnitude higher than that of LSCF and LSM. The value of k decreases when Ni is replaced by Cu in the lattice, La₂CuO_{4+δ} and when La is replaced with Sr to increase the concentration of oxygen vacancies. These features are correlated to the nature of the elements in site A and B and their oxidation state. Shaw et al. have shown that the electrocatalytic properties of A₂BO_{4+d}- type materials depend on the cation, M, in the perovskite layer,²¹ and studies of the (La,Sr)(Ni,M) systems have been shown that the oxygen diffusion is also affected by the nature of the cation on the A site.²² Electrochemical studies on these materials have shown that the rate-determining step of the ORR under air is not due to oxygen diffusion but surface processes, or k.

Compared to the perovskite-type oxides, the K₂NiF₄ structure accommodates a wide variety of oxygen stoichiometries. Furthermore, excess oxygen can be incorporated in its interstitial species, providing an attractive alternative to the vacancy-based conduction mechanism present in perovskite or fluorite oxides. A network of unoccupied interstitial sites exists when the oxygen content is four and they become partially occupied when the material oxidizes. For example, recent studies have shown that in LN-based phases, the bulk ionic transport occurs via diffusion of interstitial ions in the rock salt type layers and vacancies in the perovskite layers of K₂NiF₄-type structure.^{22,23}

Electrical studies have shown that most LN-based materials exhibit semi-conductor-like behavior in the range 300-750 K and an apparent transition to pseudometallic behavior at higher temperatures.²⁴ The transition results from oxygen loss on heating, resulting in decreasing p-type carrier concentration; the electronic-hole transport mechanism is via small polarons tip to 1250 K. The electronic conductivity reported for La₂NiO₄-based materials is small (50 S·cm⁻¹) compared to that of LSM oxide.²⁴ However, the LN conductivity can be improved by doping with Sr.²⁵

Lanthanum nickelate, La₂NiO_{4+δ} or LN, with the perovskite-related K₂NiF₄ (A₂BO_{4+δ}) structure, exhibits a moderately low electrical resistivity of 3 Ω·cm, a D*=2×10⁻⁷ cm²/s, and k=2×10⁻⁶ cm/s. LN may have certain advantages over perovskite LaNiO₃ because of the high resistance of LaNiO₃ compared to LSCF, LSC, and LSM, and its loss of performance due to formation of La₂Zr₂O₇, NiO, and La₂NiO₄ secondary phases over time.²⁶ The K₂NiF₄ phase of LN is thermodynamically stable,²⁷ and chemically and mechanically compatible with YSZ.²⁸ LN performs well as an oxygen separation membrane, its performance only surpassed by LSC among the materials in Table 1,²⁹ conforming that it is a good MIEC. That LSC is a better MIEC oxygen separation membrane than LN is supported by Table 1, which is consistent with LSC having k and D* values an order of magnitude higher than those of LN.

The activation energy of LN is from 0.6 -0.8 eV, which is smaller than that of perovskites, presumably due to differences in their conduction mechanisms. The oxygen-ions in the lanthanum nickelates diffuse mainly by an interstitial mechanism in the a˜b plane,²³ and Frenkel defects in the c-direction.³⁰ Therefore, the ionic conductivity of oxygen-hyperstoichiometric LN is equivalent to YSZ and 10 times higher than that of oxygen deficient perovskites.

The thermal expansion coefficients (TECs) of the A₂BO_{4+δ} materials also make them compatible with common electrolytes such as YSZ, Sr-doped and Mg-doped LaGaO₃ (LSGM), and gadolinia-doped ceria (CGO). The TEC of La₂Ni_{0.8}Cu_{0.2}O_{4+δ} is linear from 400-1240 K with an average value of 13.3×10⁻⁶ ° C.⁻¹: YSZ is ˜9.9×10⁻⁶ ° C.⁻¹ and LSGM and Ce (Gd)O_{2-δ} have values from 10.5-12.8×10⁻⁶ ° C.⁻¹.²⁵

The A₂BO_{4+d} materials appear to be chemically stable. Nd₂₋ₓNiO_{4+δ} does not react with YSZ and CGO electrolytes after a heat treatment in air at 650° C. over five weeks.²² However, heating some of these oxides in air at 800° C. over five days, gives rise to the formation of impurities such as Ln₂Zr₂O₇ and LnNiO₃₋ₓ (with Ln=La, Nd).

The composition may comprise from about 10 or 20 to about 80 or 90 wt % La₂NiO_{4+δ} and from about 10 or 20 to about 80 or 90 wt % of the ionic conductive material. Suitable ionic conductive materials for use in the La₂NiO4+δ composition include, but are not limited to, a rare earth oxide doped-ceria, samaria-doped ceria, gadolinia-doped ceria, yttria-doped ceria, ytterbia-doped ceria, dysprosia-doped ceria, holmia-doped ceria, terbia-doped ceria, erbia-doped ceria, ytterbia-stabilized zirconia, scandia-stabilized zirconia, yttria-stabilized zirconia, and LSGM.

A SOFC cathode may be made from a La₂NiO_{4+δ}-ionic conductive material cathode interlayer and a cathode current collector comprising lanthanum strontium cobaltite or lanthanum strontium manganate. These layers may be porous with contiguous porosity. This cathode may be combined with an anode and an ionic conductive electrolyte between and in contact with the cathode interlayer and the anode to form a SOFC.

A suitable cell used in the present invention may consist of the following five distinct layers: a) porous Ni+YSZ anode support, b) porous Ni+YSZ anode interlayer, c) dense YSZ electrolyte, d) porous (La₂NiO_{4+δ}+Sm₂O₃-CeO₂) cathode interlayer, e) porous La_{0.7}Sr_{0.3}CoO₃₋ₓ current collector.

The anode of the SOFC may comprise an anode interlayer in contact with the ionic conductive electrolyte and an anode support in contact with the anode interlayer. Suitable materials for these layers include, but are not limited to, porous nickel and yttria-stabilized zirconia.

An alternative construction of a SOFC uses a cathode interlayer comprising a La₂NiO_{4+δ} layer and a doped ceria layer with the cathode current collector, anode, and ionic conductive electrolyte described above. The La₂NiO_{4+δ} layer may comprise at least about 80 to 95% La₂NiO_{4+δ} and may be from about 2 or 20 microns to about 40 microns thick. The doped ceria layer may comprise samaria-doped ceria, gadolinia-doped ceria, yttria-doped ceria, ytterbia-doped ceria, dysprosia-doped ceria, holmia-doped ceria, erbia-doped ceria, or terbia-doped ceria and may be at least about 2 or 20 microns thick.

These SOFCs may be used by connecting an electrical load to the cathode and the anode, supplying an oxidant, such as oxygen, to the cathode and fuel to the anode, and heating the SOFC to a temperature sufficient to initiate reduction of the oxygen and oxidation of the fuel. Suitable fuels include, but are not limited to, hydrogen, methane, and synfuel. The heating may be at least about 400, 500, or 600° C.

Having described the invention, the following examples are given to illustrate specific applications of the invention. These specific examples are not intended to limit the scope of the invention described in this application.

### Example 1

Synthesis of La₂NiO4+δ—La₂NiO_{4+δ} was synthesized Using a combustion technique adapted from the literature. A solution was prepared with 0.95 M glycinec (98.5%, Alfa) mixed with 0.3 M lanthanum(III) nitrate (99.99%, Alfa) and 0.15 M nickel(II) nitrates (99.9985%, Alfa) in 18 mΩ·cm water. The solution was evaporated on a hot plate from a beaker with stirring at 90° C. for several hours until it violently ignited, leaving an amorphous, black powder. For safety, less than 100 mL in an 800 mL beaker was used for each combustion reaction, and worked in a closed hood. The amorphous powder was ground in an agate mortar and then heated in air at 5° C./min to 1100° C. and held for 2 h before cooling to room temperature at 5° C./min. The purity of the La₂NiO_{4+δ} phase was confirmed by X-ray diffraction and matching to JCPDS reference 34-0314. SEM (Leo Supra55) showed LN agglomerates less than 1 μm in diameter.

### Example 2

Single cell testing—The suitability of LN as a SOFC cathode has only been reported in ex situ tests and on “symmetrical cells” with two air electrodes.^{28,31} The objective of this example was to confirm the suitability of LN as a SOFC cathode by evaluating it in full “dime” cells under an air/H₂ gradient. The LN was evaluated as a stand-alone MIEC, and in bi-layer composite cathodes. With this approach, measured performance was interpreted based on available out of cell property measurements.

Anode-supported SOFC “dime cells” 2.6 cm in diameter were prepared at the University of Utah using previously developed methods.³ The anodes were 0.5 to 1 mm thick and the YSZ electrolyte was 8 μm thick. To make the cathode interlayer, ethylene glycol slurries of LN, SDC (Praxair), or 50:50 LN:SDC were ball milled with YSZ milling balls for 12 h. The final LN particle size was 0.2 μm, and the SDC particle size was about 0.5 μm. The slurries were painted in a 1 cm² disk onto the YSZ electrolyte, doctor-bladed to 25 μm, dried on a hot plate, and then heated in air at 5° C./min to 1200° C. and held for 1 h. After firing, a thicker layer of LN, LSM (Praxair) or LSC (Praxair) was applied by the same process and then was fired at 1150° C. in air for 1 h. SEM of the cross-section of fractured cells confirmed the thickness, porosity and adhesion of each electrode layer.

The cell was mounted in single cell apparatus described elsewhere where the cathode was exposed to open air, and the anode chamber was formed with an alumina tube.² Contact to the cell was made by spring loading between 1 cm² silver mesh at the cathode and 1 cm ² nickel mesh at the anode. Neither platinum nor silver paste was used. The entire set-up was inserted into a furnace and heated to 800° C. with the anode under hydrogen so that the NiO was reduced to Ni, resulting in a porous Ni-YSZ composite anode with porosity of about 48%.

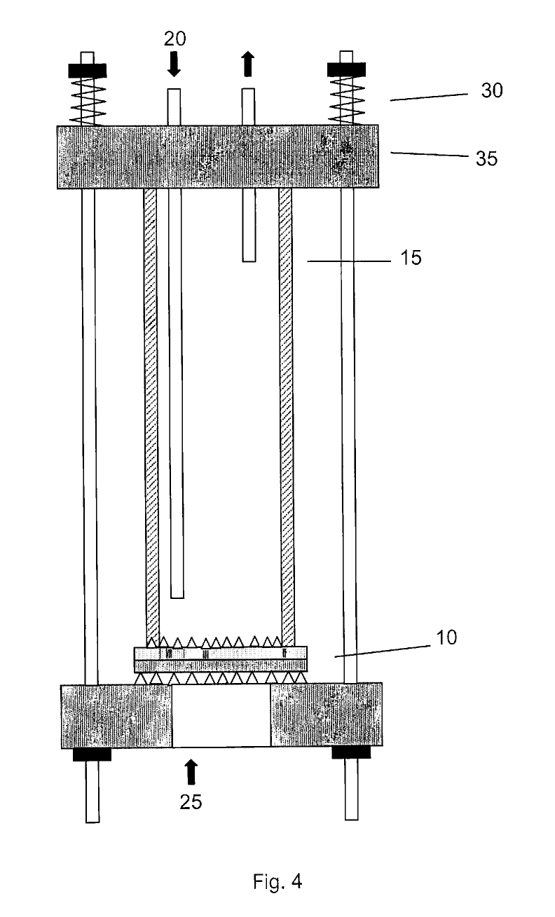

For testing, a typical cell was mounted in a test apparatus, a schematic of which is shown in FIG. 4. This apparatus was developed at the University of Utah to measure the performance of single cell.³ A fuel cell 10 was attached to two alumina ceramics by multiple alumina tube supports 15. Fuel 20 and oxidant 25 were supplied through the ends of the alumina tubes. A mechanical load was applied through an external spring 35 against steel ring 40 to ensure good sealing. Silver foil and mica sheets were used as gaskets. Silver mesh current collectors were attached to cathode and anode. After assembly the entire set-up is inserted into furnace to the desired operational temperatures. Electrical circuit measures and/or uses the electrical current produced.

For electrochemical testing, the furnace was set to 600 to 800° C., and the hydrogen was bubbled through water at room temperature and fed into the cell at 300 mL/min; air was flowed at 550 mL/min to the cathode. The ASR was measured using two methods. The first was the current interruption technique² using a Solartron S11287 Electrochemical Interface and Agilent 54622A Digital Oscilloscope. The second was from slope of ΔV/ΔI from the polarization curves over a range of voltages.

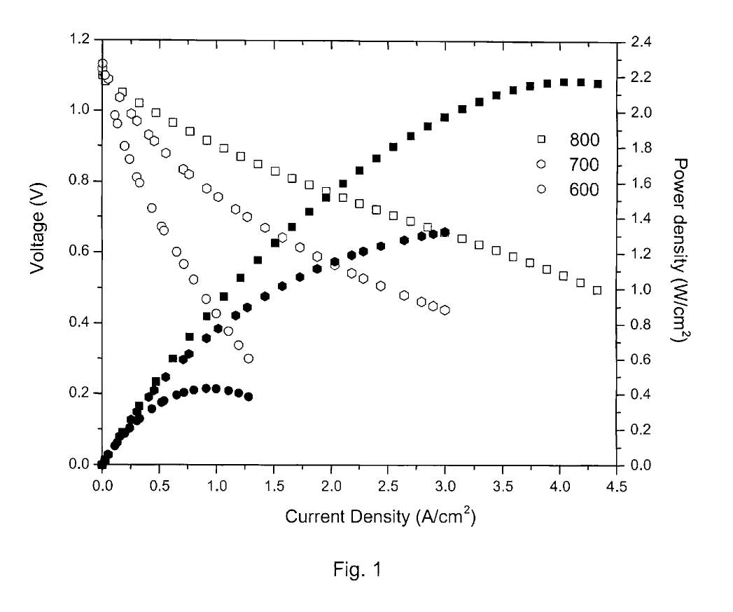

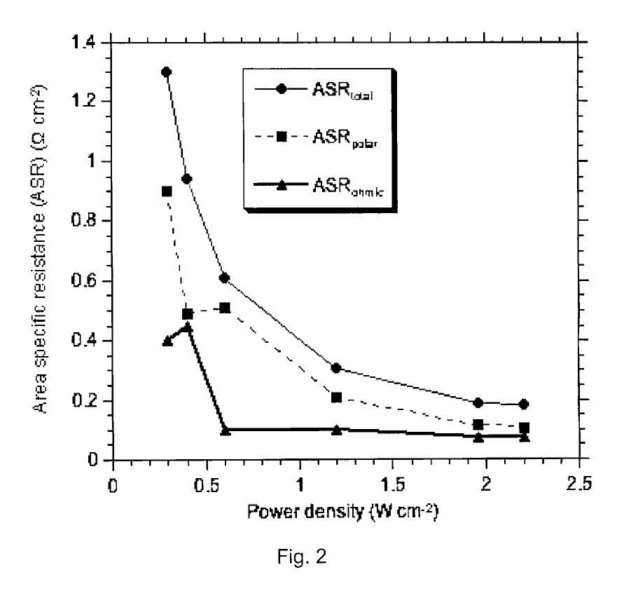

The power densities and area specific resistance (ASR) of SOFC button cells with six different cathode configurations are listed in Table 2, with the polarization curves for cell 6 at 600, 700, and 800° C. shown in FIG. 1 (H₂:air=300 mL/min:550 mL/min; electrolyte thickness: 8 μm). The ASR measured by current interruption (CI) determines the total ohmic contribution of the cell, or ASR_{ohmic}. The ASR measured from the slope of voltage (V) and current density (I) in the near linear regime of the polarization curve represents the total resistance of the cell from both ohmic and polarization losses (activation+concentration), or ASRₜₒₜₐₗ. The difference of the two ASR values, or ASRₜₒₜₐₗ−ASP_{ohmic}, is thus a measure of the polarization losses of the fuel cells, and is designated as ΔASRₚₒₗₐᵣ. Table 2 lists the values for ΔASRₚₒₗₐᵣ. FIG. 2 illustrates that the power density of the cells was approximately inversely proportional to the ASRₜₒₜₐₗ. In high performance cells (power densities>0.5 W/cm²), the power density was also approximately inversely proportional to ΔASRₚₒₗₐᵣ with little influence from ASR_{ohmic}. Only Cells 1 and 2 with power densities<0.5 W/cm² were affected by the ASR_{ohmic}. In cells 3 and 4, the dominant contribution was from ΔASRₚₒₗₐᵣ. However, when the polarization resistance became very small, the ohmic contribution began to dominate. Note that in cells 5 and 6, the ohmic contribution was about the same as ΔASRₚₒₗₐᵣ.

TABLE 2
Power density at 0.7 V and 800° C., Maximum power density at 800° C., and
ASR values at 800° C. for different cathode compositions on anode supported Ni-YSZ
with YSZ electrolyte (9 ± 1 μm thick) - Anode support porosity: 48 vol %

| Cell | | | | | |
|---|---|---|---|---|---|
| 1 | 2 | 3 | 4 | 5 | 6 |

Current collector (μm)

| | | | | | | |
|---|---|---|---|---|---|---|
| LMS | — | — | — | 33 ± 1 | — | — |
| LSC | 50 ± 1 | — | 48 ± 1 | — | 50 ± 1 | 50 ± 1 |
| LN | — | 20 ± 1 | — | — | — | — |

Interlayer (μm)

| | | | | | | |
|---|---|---|---|---|---|---|
| SDC | — | — | 13 ± 1 | — | — | — |
| LN | 17 ± 1 | — | — | — | — | — |
| SDC + LN | — | 13 ± 1 | — | 7 ± 1 | 20 ± 1 | 20 ± 1 |
| Anode thickness (μm) | 1000 | 1000 | 1000 | 1000 | 1000 | 500 |
| Power density at 0.7 V and 800° C. (W/cm²) | 0.25 | 0.30 | 0.48 | 0.95 | 1.62 | 1.90 |
| Max. power density at 800° C. (W/cm²) | 0.30 | 0.40 | 0.60 | 1.2 | 1.96 | 2.20 |
| ASR_{ohmic} at 800° C. (Ω · cm²) | 0.40 | 0.45 | 0.10 | 0.10 | 0.075 | 0.075 |
| ASRₜₒₜₐₗ at 800° C. (Ω · cm²) | 1.3 | 0.94 | 0.61 | 0.31 | 0.19 | 0.18 |
| ΔASRₚₒₗₐᵣ (Ω · cm²) | 0.9 | 0.49 | 0.51 | 0.21 | 0.115 | 0.105 |

Despite predictions that LN would be a good catalyst layer, Cell 1 with a LN-only interlayer and an LSC current collector exhibited the lowest power density, 0.3 W/cm², of the cells tested. FIG. 2 clearly shows that this cell had the highest ΔASRₚₒₗₐᵣ, indicating that the LN did not serve effectively as a MIEC cathode catalyst and had poor kinetics for oxygen reduction despite its reportedly high D* and k values. Cell 1 also had a high ASR_{ohmic}, despite the low electronic resistivity of both the LN and LSC (see Table 1). Because the LN has higher electronic resistivity than LSC and LSM, it did not serve well as a current collector. This was illustrated by Cell 2, which had a low power density of 0.4 W/cm², mainly due to its high ASR_{ohmic}, despite LN+SDC composite interlayer. Note that a LN+SDC interlayer combined with a LN current collector also had relatively high polarization losses.

Cell 3 demonstrated that SDC alone is also a poor interlayer catalyst. It had a low ASR_{ohmic} (0.1 Ω·cm²) due to the low ionic resistivity of SDC and low electronic resistivity of its LSC current collector, but its high ΔASRₚₒₗₐᵣ resulted in a maximum power density of only 0.6 W/cm². These results support that either a MIEC or a composite mixed ionic-electronic conductor may be beneficial to ensure low polarization losses or good kinetics for the ORR.

Similar to Cell 3, Cell 4 had an ASR_{ohmic=}0.1 Ω·cm², but exhibited double the power density (1.2 W/cm²) due to a considerably lower ΔASRₚₒₗₐᵣ. Unlike Cell 3, Cell 4 had a composite interlayer of LN and SDC, and LSM current collector. The significant decrease in ΔASRₚₒₗₐᵣ and increase in catalytic activity is attributed to the implementation of this composite interlayer.

Cell 4 had a LSM current collector and a relatively thin interlayer of 7 μm (optimum is 20 μm).^{2,32} As the cell was improved in Cell 5 with a LSC current collector and a 20 μm-thick LN+LSC interlayer, the maximum power density increased by 60% to 1.96 W/cm². These two changes caused only a slight decrease in the ASR_{ohmic} from 0.1 to 0.075 Ω·cm², and most of the difference in the cell was the result of the ΔASRₚₒₗₐᵣ decreasing from 0.21 to 0.12 Ω·cm². The power density was increased finally in Cell 6 to 2.2 W/Cm² by reducing the anode thickness to 500 μm, causing little change in the ASR_{ohmic} but a decrease in the ΔASRₚₒₗₐᵣ to 0.105 Ω·cm², thus indicating that at these low levels, some of the polarization losses are due to the anode.

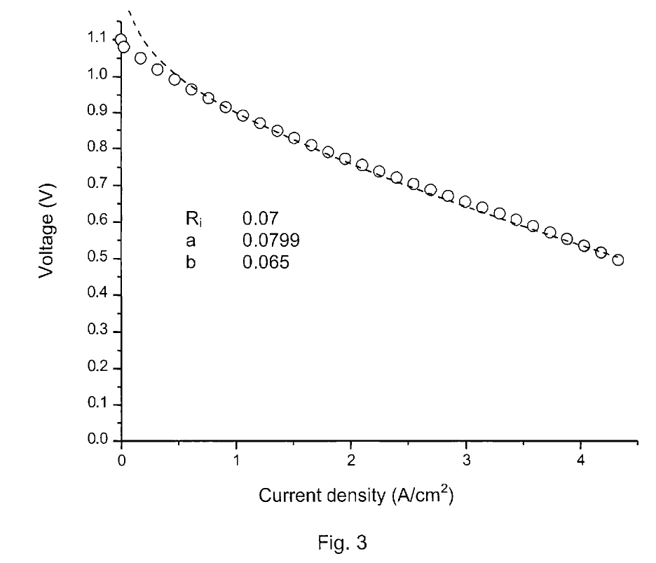

The polarization curves for these LN-based cells were fit to the parametric model developed earlier for composites of ionic and electronics conductors.^{2,3,33} FIG. 3 shows the fit. The resulting effective gas phase diffusivities of the cathode interlayer, D_{O}_{₂}_{-N}^{eff(2)}, cathode current collector, D_{O}_{₂}_{-N}_{₂}^{eff(1)}, anode interlayer, D_{H}_{₂}_{-H}_{₂}_{O}^{eff(2)}, and anode support, D_{H}_{₂}_{-H}_{₂}_{O}^{eff(1)} were 0.135, 0.04, 0.65 and 0.09 cm²/s, respectively. These values are nearly comparable to those from LSM/YSZ cathode-based cells (0.14, 0.04, 0.68 and 0.08 cm²/s),³ indicating the microstructural details were similar in the present cells. The fit of the ohmic resistance, Rᵢ is 0.07Ω·cm², and compares well with the ASR_{ohmic} determined by current interruption (0.075Ω·cm²). Tafel values, a=0.08 and b=0.065, were obtained for current densities above 0.5 A/cm² for which the Tafel law is applicable. The estimated exchange current density, i₀, 292 mA/cm² was somewhat lower than the one observed for LSMV/YSZ cells, (325 mA/cm²), despite the fact that the LN/SDC cell exhibited higher power density.³ This in part can be attributed to the higher ohmic resistance for the LSM/YSZ cells (0.104 Ω·cm²). The indication is that with further optimization of LN/SDC cathode-based cells, even higher performance may be achievable.

### Example 3

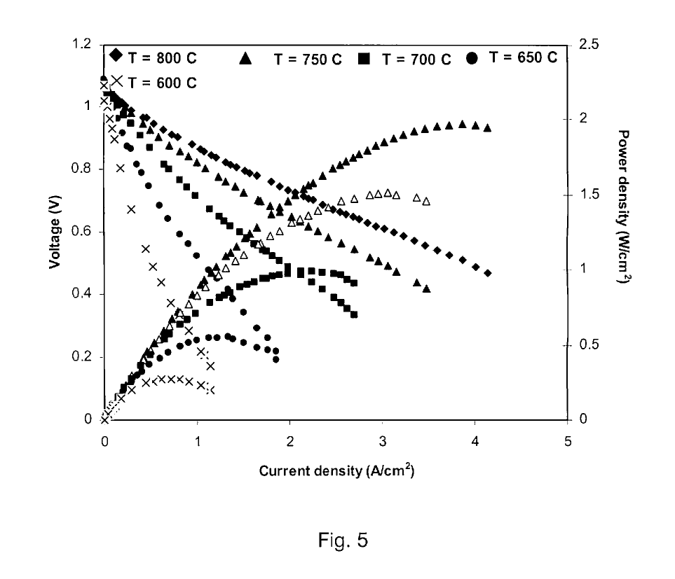

Temperature testing—FIG. 5 shows the performance of a cell having a porous 10-20 μm thick interlayer of (La₂NiO_{4+δ}+SDC) and a porous 50 μm thick current collector of LSC tested at 600, 650, 700, 750, and 800° C. The maximum power density (MPD) was ˜1.96 W/cm² at 800° C., ˜1.5 W/cm² at 750° C., ˜1 W/cm² at 700° C., ˜0.55 W/Cm² at 650° C., and ˜0.28 W/cm² at 600° C.

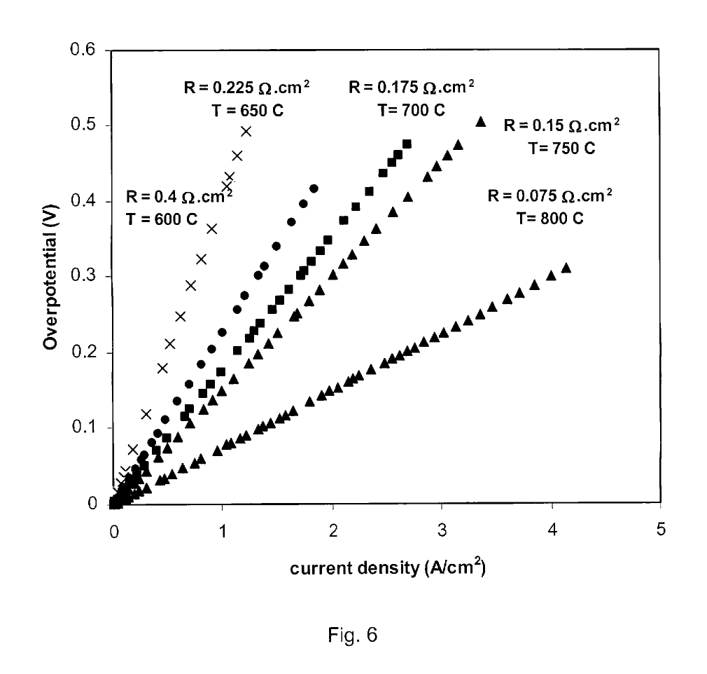

The results of the area specific ohmic resistance (ASR) measured by current interruption on this cell are reported on FIG. 6 for various temperatures. As seen in this figure, the ASR increased with decreasing temperature; the ASR increased from 0.076 to 0.4 Ω·cm² with the decrease of temperature from 800° C. to 600° C. The ASR increased from 0.085 Ω·cm² at 800° C. to 0.15 Ω·cm² at 600° C. for an optimized cell with the following materials set: LSM, YSZ, Ni.

Obviously, many modifications and variations of the present invention are possible in light of the above teachings. It is therefore to be understood that the claimed invention may be practiced otherwise than as specifically described. Any reference to claim elements in the singular, e.g., using the articles “a,” “an,” “the,” or “said” is not construed as limiting the element to the singular.

### REFERENCES

1. Adler, Chem. Rev., 104, 4791 (2004)
2. Tanner et al., J. Electrochem. Soc., 144(1), 21 (1997)
3. Zhao et al., J. Power Sources, 141, 79 (2005)
4. Lee et al., J. Power Sources, 115, 219 (2003)
5. Adler et al., J. Electrochem. Soc., 144, 1884 (1997)
6. Steele et al., Solid State Ionics, 135, 445 (2000)
7. Jiang et al., J. Electrochem. Soc., 150, A942 (2003)
8. Simner et al., J. Power Sources, 113, 1 (2003)
9. Armstrong at al., J. Electrochem. Soc., 153(3), A515 (2006)
10. Ji et al., Solid State Ionics, 176, 937 (2005)
11. De Souza et al., Solid State Ionics, 106, 175 (1998)
12. Yamamoto et al., Solid State Ionics, 22, 241 (1987)
13. van Doorn et al., Solid State Ionics, 96, 1 (1997)
14. Chen et al., J Electrochem. Soc., 142, 491 (1995)
15. Tai et al., Solid State Ionics, 76, 273 (1995)
16. Skinner et al., Solid State Ionics, 135, 709 (2000)
17. Vashook et al., Solid State Ionics, 119, 23 (1999).
18. Eguchi et al., Solid State Ionics, 52, 165 (1992)
19. Manning et al., Solid State Ionics, 93, 125 (1997)
20. Huang et al., J. Am. Ceram. Soc., 81, 357 (1998)
21. Shaw et al., Proc. 4th Eur. Forum, A. J. McEvoy, Editor, p. 611 (2000)
22. Boehm, Thesis, University of Bordeaux (2002)
23. Bassa et al., 5^{th} European solid oxide fuel cell forum, 1-5 Jul. 2002, Lucerne/Switzerland. ed. J. Huijsmans. Oberrohrdorf(Switzerland): European Fuel Cell Forum, 2002. p. 586-593. ISBN 3-905592-10-X
24. Nishiyarna et al., Solid State Communications, 94, 279 (1995)
25. Kharton et al., J Mater. Chem., 9, 2623 (1999)
26. Ralph et al., J. Mater. Sci., 36, 1161 (2001)
27. Demina et al., Inorg. Mater., 41(7), 736 (2005)
28. M. L. Fontaine, Thesis, University of Toulouse (2002)
29. Smith et al., J Electrochem. Soc., 153, A233 (2006)
30. Minerviniet al., J. Mater. Chem., 10, 2349 (2000)
31. Mauvy et al., J. Electrochem. Soc, 153. A1547 (2006)
32. Virkar et al., Solid State Ionics, 131, 189 (2000)
33. Hu et al., J. Power Sources, 152, 22 (2005)

What is claimed is:

1. A composition of matter comprising a solid mixture of:
La₂NiO_{4+δ}; and
an ionic conductive material.

2. The composition of matter of claim 1, wherein the ionic conductive material is a rare earth oxide doped-ceria, samaria-doped ceria, gadolinia-doped ceria, yttria-doped ceria, ytterbia-doped ceria, dysprosia-doped ceria, holmia-doped ceria, erbia-doped ceria, or terbia-doped ceria.

3. The composition of matter of claim 1, wherein the ionic conductive material is yttria-stabilized zirconia.

4. The composition of matter of claim 1, wherein the ionic conductive material is Sr-doped and Mg-doped LaGaO₃.

5. The composition of matter of claim 1, wherein the composition comprises from about 10 to about 90 wt % La₂NiO_{4+δ} and from about 10 to about 90 wt % of the ionic conductive material.

6. A solid oxide fuel cell cathode comprising:
a cathode interlayer comprising the composition of matter of claim 1; and
a cathode current collector comprising lanthanum strontium cobaltite or lanthanum strontium manganate.

7. The solid oxide fuel cell cathode of claim 6, wherein the cathode interlayer and the cathode current collector are porous with contiguous porosity.

8. A solid oxide fuel cell comprising:
the solid oxide fuel cell cathode of claim 6;
an anode; and
an ionic conductive electrolyte between and in contact with the cathode interlayer and the anode.

9. The solid oxide fuel cell of claim 8, wherein the anode comprises:
an anode interlayer in contact with the ionic conductive electrolyte; and
an anode support in contact with the anode interlayer.

10. The solid oxide fuel cell of claim 9, wherein the anode interlayer and the anode support comprise porous nickel and yttria-stabilized zirconia.

11. A method comprising:
providing the solid oxide fuel cell of claim 8;
connecting an electrical load to the solid oxide fuel cell cathode and the anode;
supplying oxidant to the solid oxide fuel cell cathode;
supplying a fuel to the anode; and
heating the solid oxide fuel cell to a temperature sufficient to initiate reduction of the oxygen and oxidation of the fuel.

12. The method of claim 11, wherein the temperature is at least about 400° C.

13. The method of claim 11, wherein the fuel is hydrogen.

14. A solid oxide fuel cell comprising:
a cathode interlayer comprising a La₂NiO_{4+δ} layer and a doped ceria layer;
a cathode current collector comprising lanthanum strontium cobaltite or lanthanum strontium manganate;
an anode; and
an ionic conductive electrolyte between and in contact with the cathode interlayer and the anode.

15. The solid oxide fuel cell of claim 14;
wherein the La₂NiO_{4+δ} layer comprises at least about 95% La₂NiO_{4+δ} and is from about 2 microns to about 40 microns thick; and
wherein the doped ceria layer comprises a rare earth oxide doped-ceria, samaria-doped ceria, gadolinia-doped ceria, yttria-doped ceria, ytterbia-doped ceria, dysprosia-doped ceria, holmia-doped ceria, terbia-doped ceria, or erbia-doped ceria, and is at least about 2 microns thick.

16. The solid oxide fuel cell of claim 14, wherein the anode comprises:
an anode interlayer in contact with the ionic conductive electrolyte; and
an anode support in contact with the anode interlayer.

17. The solid oxide fuel cell of claim 16, wherein the anode interlayer and the anode support comprise porous nickel and yttria-stabilized zirconia.

18. A method comprising:
providing the solid oxide fuel cell of claim 14;
connecting an electrical load to the solid oxide fuel cell cathode and the anode;
supplying oxidant to the solid oxide fuel cell cathode;
supplying a fuel to the anode; and
heating the solid oxide fuel cell to a temperature sufficient to initiate reduction of the oxygen and oxidation of the fuel.

19. The method of claim 18, wherein the temperature is at least about 400° C.

20. The method of claim 18, wherein the fuel is hydrogen.
